(19) United States
(12) Patent Application Publication
(10) Pub. No.: US 2019/0103681 A1
(43) Pub. Date: Apr. 4, 2019

(54) FEED LAMINATION TOOL

(71) Applicant: Kymeta Corporation, Redmond, WA (US)

(72) Inventors: Mike Slota, Kirkland, WA (US); Alex Truesdale Perry, Redmond, WA (US); Andrew Turner, Seattle, WA (US); Bryan McCrary, Redmond, WA (US); Stephen Olfert, Kent, WA (US); Benjamin Ash, Seattle, WA (US)

(21) Appl. No.: 16/148,811

(22) Filed: Oct. 1, 2018

Related U.S. Application Data
(60) Provisional application No. 62/568,199, filed on Oct. 4, 2017.

(51) Int. Cl. H01Q 21/00; H01P 11/00; H01Q 1/28; H01Q 15/14

(52) U.S. Cl. CPC H01Q 21/0087; H01Q 15/141; H01Q 1/288; H01P 11/006

(57) ABSTRACT

Embodiments of a tool are described. The tool includes an assembly plate having a top surface and a bottom surface. The assembly plate also includes a raised area on the top surface, the raised area centered on a central alignment hole extending from the top surface to the bottom surface through the entire thickness of the raised area. An alignment ring is formed in the top surface of the raised area, wherein the alignment ring surrounds the central alignment hole and is concentric with the central alignment hole. A fitting including a base tier, a plurality of stacked concentric tiers of different radii on a first side of the base tier, and a retainer on a second side of the base tier, wherein an axis of the fitting is adapted to be aligned with the center of the central alignment hole.

### CROSS-REFERENCE TO RELATED APPLICATIONS

This application claims priority under 35 U.S.C. § 119(e) to U.S. Provisional Application No. 62/568,199, filed 4 Oct. 2017 and still pending. The contents of the provisional application are hereby incorporated by reference in their entirety.

### TECHNICAL FIELD

The disclosed embodiments relate generally to laminated material stacks and in particular, but not exclusively, to a tool and method for forming a laminated material stack for use in a satellite antenna.

### BACKGROUND

During manufacture of a laminated assembly, alignment among the many layers that make up the assembly is usually achieved by aligning the edges of the layers to some common reference point. This works fine for most assemblies. But occasionally there is a laminate assembly in which accurate alignment at the center of the assembly is more important than accurate alignment of the edges. In these applications, edge alignment may prove inadequate to provide accurate enough central alignment due to manufacturing tolerances in the tools, variations in the materials, etc.

### BRIEF DESCRIPTION OF THE DRAWINGS

Non-limiting and non-exhaustive embodiments are described with reference to the following figures, wherein like reference numerals refer to like parts throughout the various views unless otherwise specified. Drawings are not to scale unless specifically designated as such.

FIG. 1 is a simplified cross-sectional view of an embodiment of an antenna including a multi-layer feed assembly.

FIG. 2 is a block diagram of an embodiment of a system using an antenna such as the one shown in FIG. 1.

FIGS. 3A-3D are drawings of an embodiment of a tool for making an embodiment of a multi-layer feed assembly for an antenna such as the one shown in FIG. 1. FIGS. 3A-3C are perspective views, FIG. 3D a cross-sectional view.

FIGS. 4A-4B are drawings of an embodiment of a part of the tool shown in FIGS. 3A-3D for making an embodiment of a multi-layer feed assembly for an antenna such as the one shown in FIG. 1. FIG. 4A is a perspective view, FIG. 4B a cross-sectional view.

FIG. 5 is a cross-sectional exploded view of an embodiment of the assembly of a multi-layer feed assembly.

FIGS. 6A-6B are perspective drawings of a part of the embodiment of an assembly shown in FIG. 5.

FIGS. 7A-7B are perspective drawings of another part of the embodiment of an assembly shown in FIG. 5.

FIGS. 8A-8B are perspective drawings of another part of the embodiment of an assembly shown in FIG. 5.

FIGS. 9A-9B are perspective drawings of another part of the embodiment of an assembly shown in FIG. 5.

FIG. 10 is a perspective drawing of another part of the embodiment of an assembly shown in FIG. 5.

### DETAILED DESCRIPTION

Embodiments are described of an apparatus, system and method for forming a material stack for a multi-layer antenna feed assembly. Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless encompassed within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the particular features, structures, or characteristics can be combined in any suitable manner in one or more embodiments.

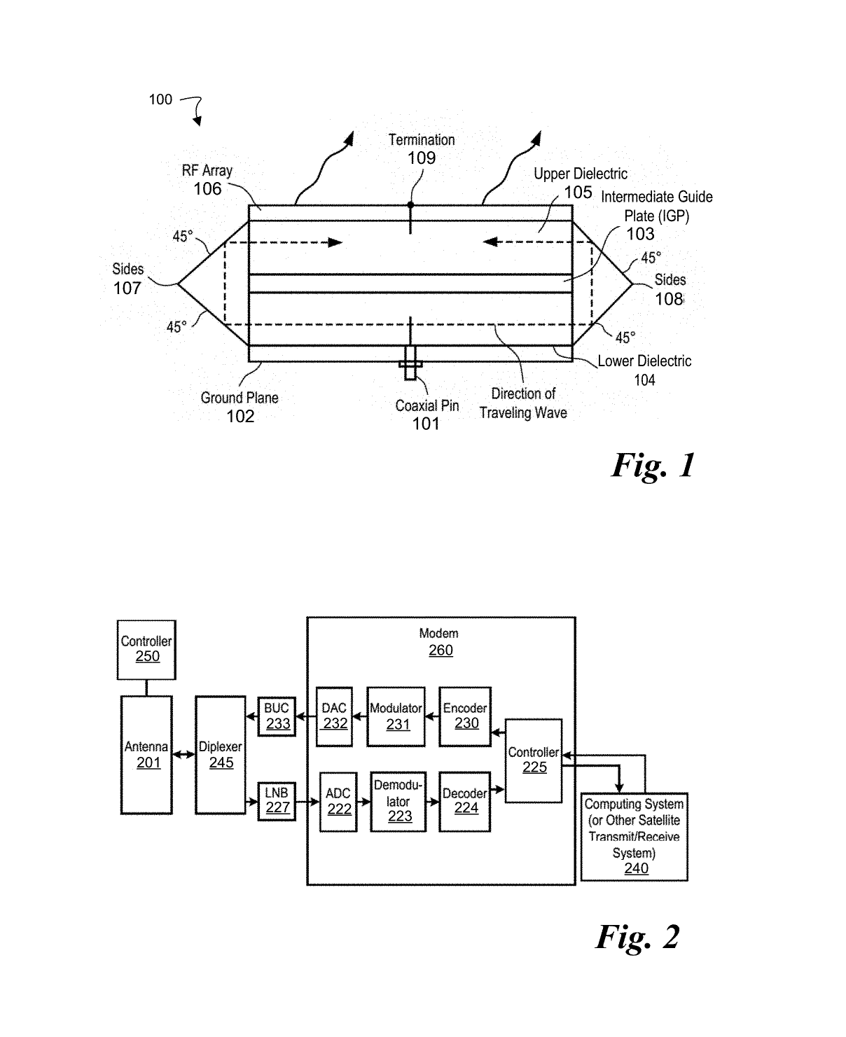

Embodiments are described of a method and apparatus for assembling a laminated material stack without keying features except for use of a center area. In one embodiment, a feed, or dielectric stack, assembly tool is used to assemble portions of a stack used in an antenna feed such as, for example, the antenna feed described in FIG. 1. In one embodiment, the assembly tool comprises a table. Using this tool, a concentric composite can be created using internal radio frequency (RF) components for alignment. Note that, as used in the description of the figures, absolute or relative positional expressions such as “top,” “bottom,” “upper,” “lower,” “above,” and “below” refer to the orientations shown in the drawings and are not intended to limit or mandate the orientation of any particular element when in actual use.

The tool and method embodiments described below are useful for assemblies with multiple components in which a high degree of concentricity between components is needed for superior performance. Examples include assemblies such as the antenna feed described below in which multiple layers must be put together so that they are accurately and repeatably concentric, meaning that the centers of every layer are aligned along an axis within tight tolerances.

FIG. 1 illustrates an embodiment of a cylindrically fed antenna 100. Antenna 100 produces an inwardly-travelling wave using a double-layer feed structure (i.e., two layers of a feed structure). In one embodiment the antenna has a circular outer shape, but this is not required. That is, non-circular inward-travelling structures can be used. In antenna 100, a coaxial pin 101 is used to excite the field on the lower level of the antenna. In one embodiment, coaxial pin 101 is a readily available 50Ω coax pin. Coaxial pin 101 is coupled (e.g., bolted) to the bottom of the antenna structure, which is conducting ground plane 102.

Separate from conducting ground plane 102 is intermediate guide plate (IGP) 103, which is an internal conductor positioned between lower dielectric layer 104 and upper dielectric layer 105—in other words, intermediate guide plate 103 is an interstitial electrically conductive layer positioned between the upper and lower dielectric layers. In one embodiment, conducting ground plane 102 and intermediate guide plate 103 are parallel to each other. Generally the distance between ground plane 102 and intermediate guide plate 103—essentially, the thickness of lower dielectric layer 104—will depend on the nature of the material used for lower dielectric layer 104. In one embodiment, the distance between ground plane 102 and intermediate guide plate 103 is 0.1-0.15″, but in other embodiments this distance can be 0.1-0.25″. In another embodiment, this distance can be λ/2, where λ is the wavelength of the travelling wave at the frequency of operation. In still other embodiments, this distance can be another fraction of λ, such as λ/4, λ/5, λ/6, etc.

Ground plane 102 is separated from intermediate guide plate 103 via a lower dielectric 104. In one embodiment, lower dielectric 104 is a flexible foam or air-like dielectric, but in other embodiments it can be a rigid or semi-rigid plastic dielectric. On top of intermediate guide plate 103 is upper dielectric layer 105. In one embodiment, upper dielectric layer 105 is plastic. The purpose of upper dielectric layer 105 is to slow the travelling wave relative to free space velocity. In one embodiment, upper dielectric layer 105 slows the travelling wave by 30% relative to free space. In one embodiment, the range of indices of refraction that are suitable for beam forming are 1.2-1.8, where free space has by definition an index of refraction equal to 1. Other dielectric materials, such as, for example, plastic, can be used to achieve this effect. Note that materials other than plastic can be used as long as they achieve the desired wave slowing effect. Alternatively, a material with distributed structures can be used as upper dielectric layer 105, such as periodic sub-wavelength metallic structures that can be machined or lithographically defined, for example.

A radio frequency (RF) array 106 is on top of upper dielectric layer 105. Generally the distance between intermediate guide plate 103 and RF array 106—essentially, the thickness of upper dielectric layer 105—will depend on the nature of the material used for the upper dielectric layer. In one embodiment, the distance between intermediate guide plate 103 and RF-array 106 is 0.1-0.15″, but in other embodiments this distance can be 0.1-0.25″. In another embodiment, this distance can be λ_eff/2, where λ_eff is the effective wavelength in the medium at the design frequency. In still other embodiments, this distance can be another fraction of λ_eff, such as λ_eff/4, λ_eff/5, λ_eff/6, etc.

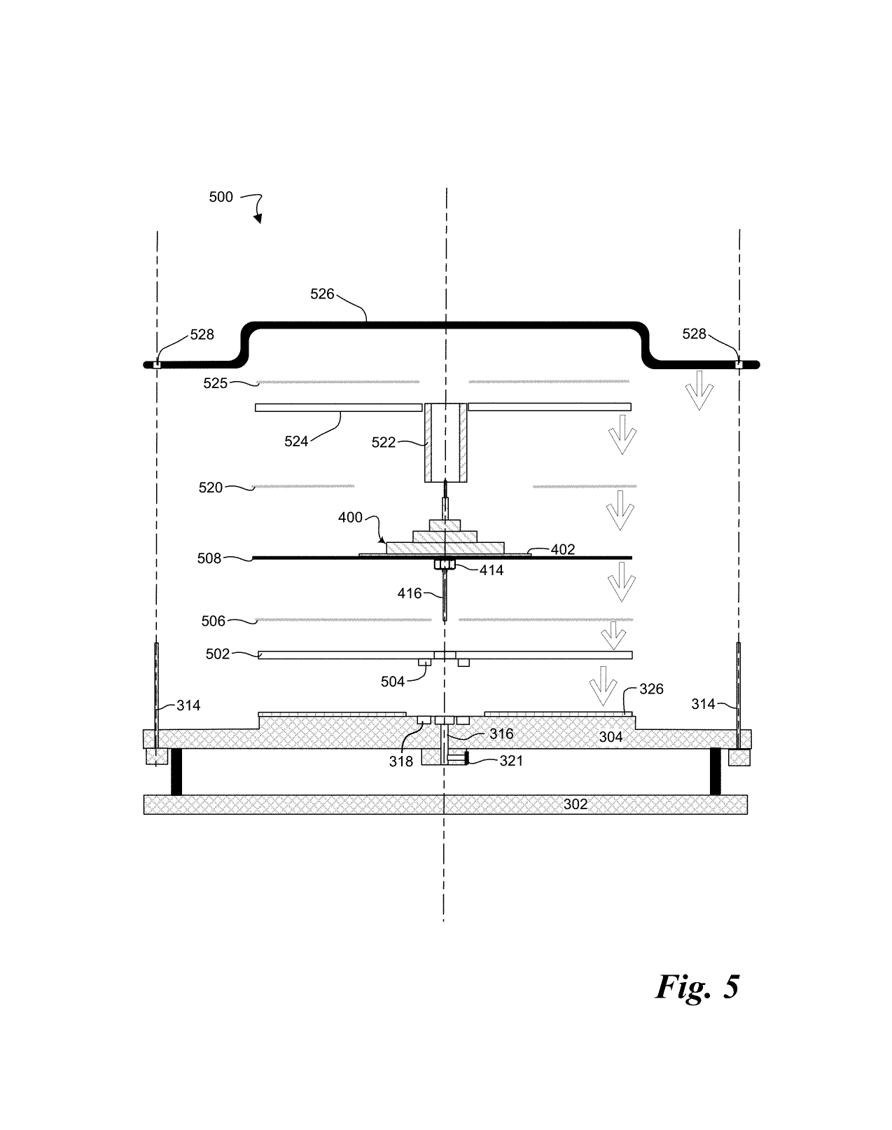

Antenna 100 includes sides 107 and 108. Sides 107 and 108 are angled to cause a travelling wave originating from coax pin 101 to be propagated from the area below intermediate guide plate 103 (lower dielectric layer 104) to the area above intermediate guide plate 103 (upper dielectric layer 105) by reflection. In one embodiment, the angle of sides 107 and 108 are at 45° angles. In an alternative embodiment, sides 107 and 108 could be replaced with a continuous radius to achieve the reflection. While FIG. 1 shows angled sides that have angle of 45 degrees, other angles that accomplish signal transmission from lower level feed to upper level feed can be used. That is, given that the effective wavelength in the lower feed will generally be different than in the upper feed, some deviation from the ideal 45° angles could be used to aid transmission from the lower to the upper feed level. For example, in another embodiment, the 45° angles can be replaced with a single step or multiple steps. In other embodiments the functions of conductive ground plane 102 and sides 107 and 108 are provided by a single waveguide structure 526 (see, e.g., FIG. 5).

In operation, when a feed wave is fed in from coaxial pin 101, the wave travels outward concentrically oriented from coaxial pin 101 in the area between ground plane 102 and intermediate guide plate 103. The concentrically outgoing waves are reflected by sides 107 and 108 and travel inwardly in the area between intermediate guide plate 103 and RF array 106. The reflection from the edge of the circular perimeter causes the wave to remain in phase (i.e., it is an in-phase reflection). The travelling wave is slowed by upper dielectric layer 105. At this point, the travelling wave starts interacting and exciting with elements in RF array 106 to obtain the desired scattering. In one embodiment, fitting 400 (described below), when set in place in an antenna feed (see, e.g., FIG. 5), performs the function of coaxial pin 101. With its concentric tiers, fitting 400 helps match the impedance between the coaxial and radial modes using its tiered transition from the input (co)axial mode (direction of propagation is through the conductor) to the radial mode (direction of propagation of the RF wave occurs from the edges of the conductor toward its center). This transition shorts the input pin to a capacitive step that compensates for the probe inductance, then impedance steps out to the full height of radial waveguide 201. The number of tiers needed to transition is related to the desired bandwidth of operation and the difference between the initial impedance of the launch and the final impedance of the guide. For example, in one embodiment, for a 10% change in bandwidth, a one-tier transition is used; for a 20% change in bandwidth, a two-tier transition is used; and for a 50% change in bandwidth, a three (or more) tier transition is used.

To terminate the travelling wave, a termination 109 is positioned at the geometric center of the antenna. In one embodiment, termination 109 can be a pin termination (e.g., a 50Ω pin). In another embodiment, termination 109 can be an RF absorber that terminates unused energy to prevent reflections of that unused energy back through the feed structure of the antenna. These could be used at the top of RF array 106

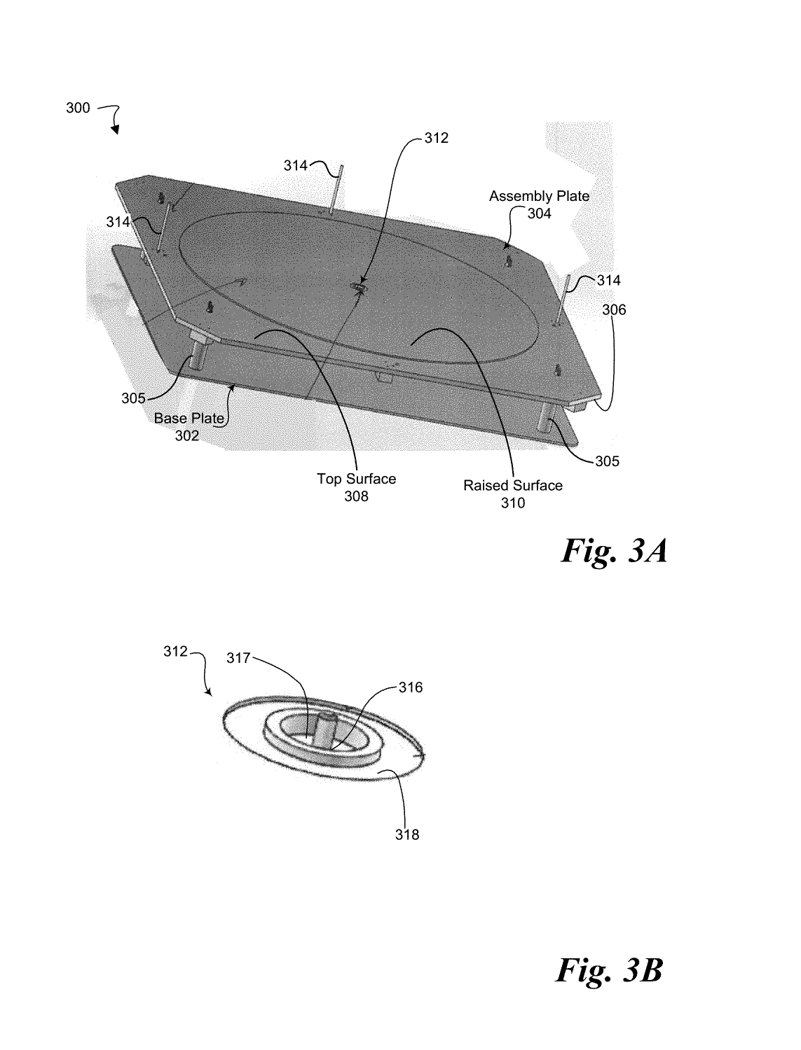

FIG. 2 illustrates, in block diagram form, an embodiment of a full-duplex communication system with simultaneous transmit and receive paths that use an antenna such as antenna 100. While only one transmit path and one receive path are shown, the communication system can include more than one transmit path and/or more than one receive path. The illustrated full-duplex communication system has many applications, including but not limited to, internet communication, vehicle communication (including software updating), etc.

Antenna 201, which in one embodiment has the construction of antenna 100, includes two spatially interleaved RF antenna arrays operable independently to transmit and receive simultaneously at different frequencies. In one embodiment, antenna 201 is coupled to diplexer 245. The coupling can be by one or more feeding networks. In one embodiment, in the case of a radial feed antenna, diplexer 245 combines the two signals and the connection between antenna 201 and diplexer 245 is a single broad-band feeding network that can carry both frequencies.

Diplexer 245 is coupled to a low noise block down converter (LNB) 227, which performs noise filtering, down-conversion, and amplification functions. In one embodiment, LNB 227 is in an outdoor unit (ODU). In another embodiment, LNB 227 is integrated into the antenna apparatus. LNB 227 is coupled to a modem 260, which is coupled to computing system 240 (e.g., a computer system, modem, etc.). Diplexer 245 provides the transmit signal to antenna 201 for transmission.

Modem 260 includes an analog-to-digital converter (ADC) 222, which is coupled to LNB 227, to convert the received signal output from diplexer 245 into digital format. Once converted to digital format, the signal is demodulated by demodulator 223 and decoded by decoder 224 to obtain the encoded data on the received wave. The decoded data is then sent to controller 225, which sends it to computing system 240. Modem 260 also includes an encoder 230 that encodes data to be transmitted from computing system 240. The encoded data is modulated by modulator 231 and then converted to analog by digital-to-analog converter (DAC) 232. The analog signal is then filtered by a BUC (up-convert and high pass amplifier) 233 and provided to one port of diplexer 245. In one embodiment, BUC 233 is in an outdoor unit (ODU). Controller 250 controls antenna 201, including the two arrays of antenna elements on the single combined physical aperture.

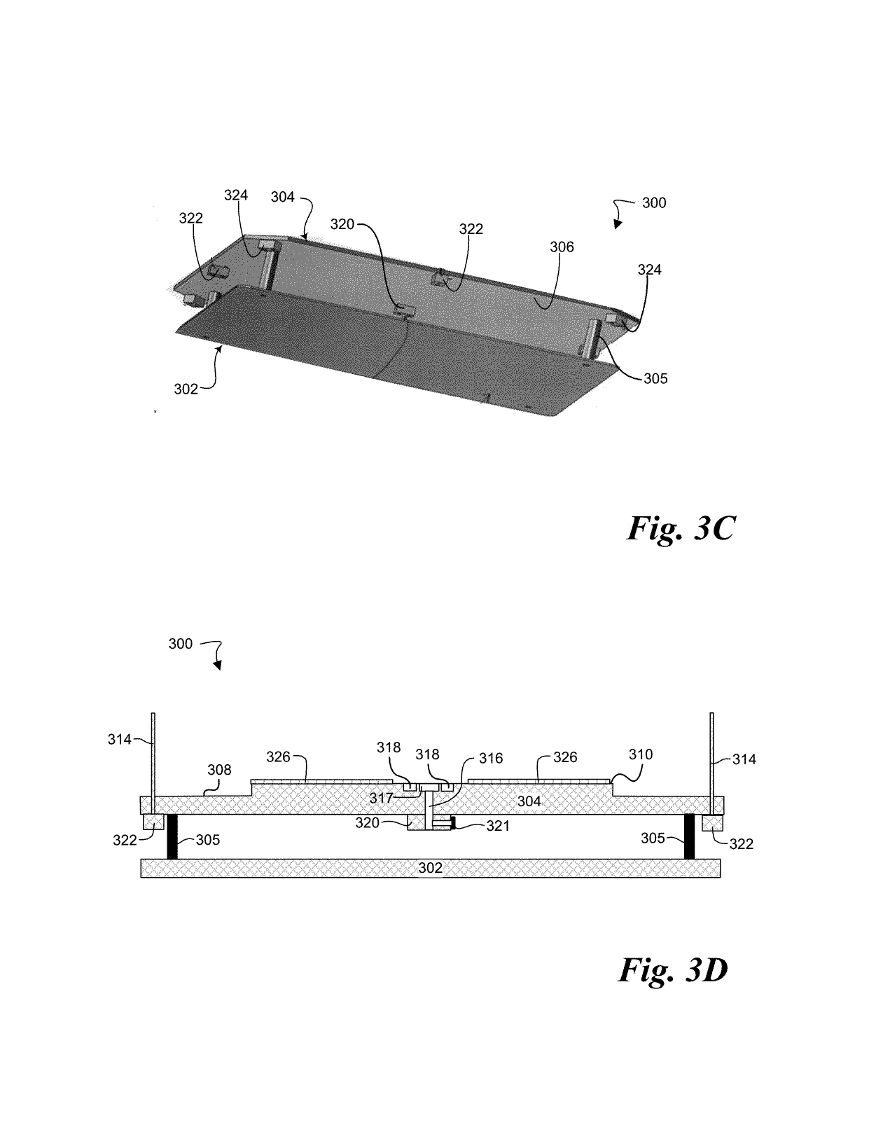

FIGS. 3A-3D together illustrate an embodiment of a tool 300 for forming a material stack such as the laminated feed assembly of antenna 100. Tool 300 includes a base plate 302 and an assembly plate 304. Assembly plate 304 is separated from the base plate 302 by uprights 305, which maintain spacing between the two plates and also removably attach assembly plate 304 to base plate 302. In one embodiment, assembly plate 304 can be secured to the uprights 305 and base plate 302 via four wing nuts. In the illustrated embodiment both base plate 302 and assembly plate 304 are quadrilateral, but in other embodiments both plates can have other shapes besides quadrilateral. In still other embodiments, base plate 302 and assembly plate 304 need not have the same shape.

Assembly plate 304 includes a top side with a top surface 308 and a raised surface 310 that is slightly higher than top surface 308 because assembly plate 304 is thicker in the area of raised surface 310. In the illustrated embodiment raised surface 310 is circular, but in other embodiments the raised surface can have a shape different than shown. Raised surface 310 allows proper positioning of components of an antenna feed structures, such as the waveguide and ensures that waveguide 526 always makes contact with the feed components rather than bottoming out on the outside edges (see, e.g., FIG. 5). In the illustrated embodiment raised surface 310 is fixed, but in other embodiments raised surface can be movable. For instance, in various embodiments assembly plate 304 can include elements that allow raised surface 310 to be moved up or down manually, mechanically, pneumatically or hydraulically.

As shown in FIGS. 3A-3B and 3D, a central alignment structure 312 is formed in the middle of raised surface 310. Central alignment structure 312 includes a central alignment hole 316 that is surrounded by a hole 317 and an alignment ring 318. Hole 317 and alignment ring 318 are used to help align the first layer to be placed on the tool. In one embodiment, hole 317 and alignment ring 318 are machined into raised surface 310. A release layer 326 can be positioned on all or part of raised surface 310 surrounding alignment structure 312 to make it easier to release the components from the tool later on; for instance, after application of a vacuum to the tool, release layer 326 prevents a vacuum forming along the raised surface that would make it difficult to remove the components later. In one embodiment, release layer 326 can be a layer of mesh that is positioned on raised surface 310, but in other embodiments the release layer can be something else. In still other embodiments, release layer 326 need not be a layer separate from raised surface 310, but can instead be formed in the raised surface, for instance by forming trenches in the raised surface. In still other embodiments, release layer 326 can be implemented with mechanical valves that that will purge the vacuum and can be inserted into assembly plate 304. Other potential embodiments of release layer 326 can use mechanical spring loaded systems, or manual ball valve systems integrated into assembly plate 304. This can be important because if the operator uses excessive force to move the feed assembly, he/she will damage the waveguide which could affect final antenna performance.

Peripheral alignment pins 314 extend upward from top surface 308 and are used to help align subsequent layers of the antenna feed, such as the waveguide, on the tool (see, e.g., FIG. 5). In one embodiment, peripheral alignment pins 314 are inserted into holes drilled/reamed to precision in three locations on the assembly plate. Bushings can be inserted into the holes for various purposes, such as avoiding material incompatibility between the assembly plate and the peripheral alignment pins. In one embodiment, peripheral alignment pins 314 can be manually inserted into assembly plate 304, but in other embodiments the alignment pins can be part of assembly plate 304 and can be extended or retracted mechanically, hydraulically, electrically, or pneumatically.

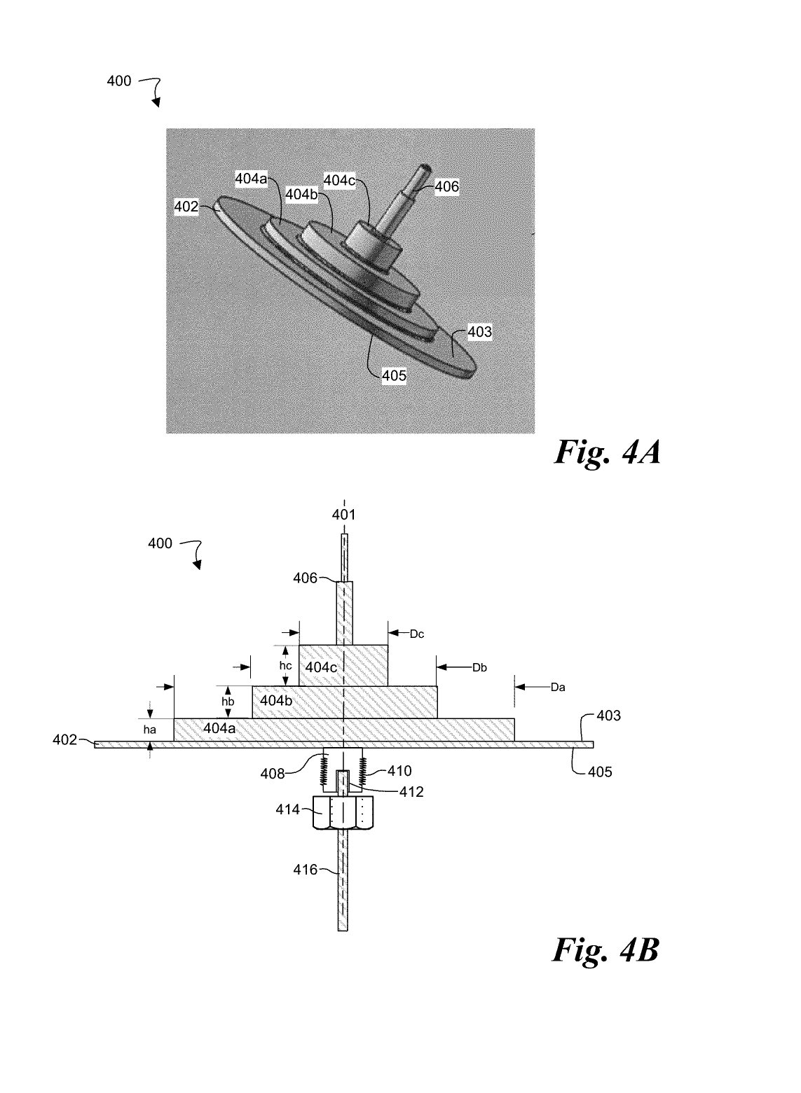

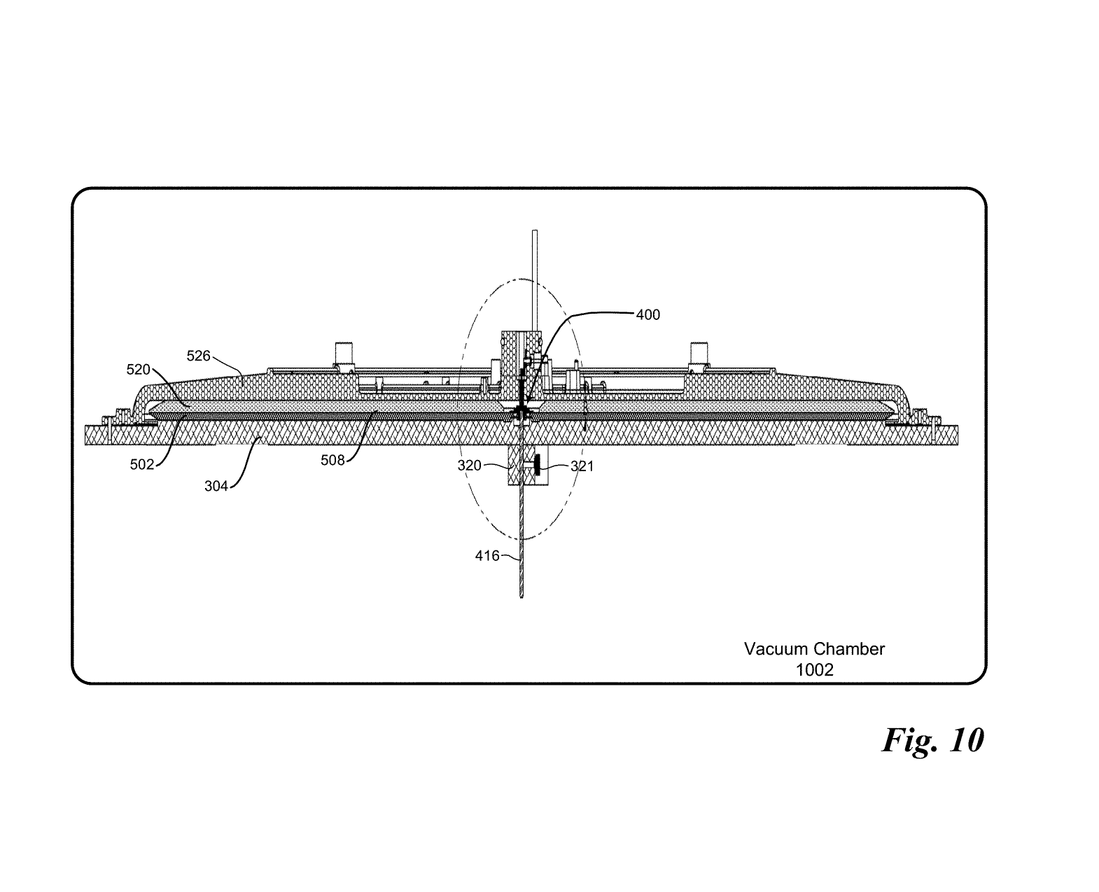

As shown in FIGS. 3C-3D, bottom surface 306 of assembly plate 304 is substantially planar. A pin block 320 is positioned on bottom surface 306 surrounding the exit of central alignment hole 312. Pin block 320 itself has a hole extending through its thickness so that a central alignment pin 416 (see, e.g., FIG. 4B) can later be inserted through central alignment hole 316 and through pin block 320. Pin block 320 also includes a set screw 321 to hold a central alignment pin 416 in place when inserted. Pin stops 322 are positioned on bottom surface 306 along the edges of assembly plate 304 to retain peripheral alignment pins 314 in place. Corner supports 324 are positioned at each corner of bottom surface 306 to later help support assembly plate 304 once it is removed from uprights 305 and put on a surface, such as when it is put under vacuum in a vacuum chamber (see, e.g., FIG. 10).

FIGS. 4A-4B illustrate an embodiment of a fitting 400 shaped into concentric tiers that can be used with tool 300. FIG. 4A is a perspective view, FIG. 4B a cross-sectional view. Fitting 400 includes a base tier 402 having a first side 403 and a second side 405. A plurality of tiers 404 are concentrically stacked on first side 403. In the illustrated embodiment the plurality of tiers 404 includes three tiers 404a-404c stacked on first side 403, but in other embodiments can have more or less tiers than shown. In the illustrated embodiment, fitting 400 is axisymmetric about axis 401, so that base tier 402 and tiers 404a-404c are round, but in other embodiments base tier 402 and tiers 404a-404c need not be axisymmetric. In an axisymmetric embodiment, each tier 404 has thickness h and diameter D: tier 404a has thickness ha and diameter Da, tier 404b has thickness hb and diameter Db, and so on. In the illustrated embodiment, the diameters D of tiers 404a-404c decrease with distance from base tier 402 (i.e., Dc≤Db≤Da) and the tier thicknesses h increase with distance from base tier 402 (i.e., hc≥hb≥ha), but the sequence of diameters D and heights h can be different in other arrangements of tiers 404. A stem 406 sticks up from the top of topmost tier 404c. In a completed feed, stem 406 will point toward the back of the antenna, so that it can be used as a feed pin (i.e., an electrical contact point) through which to inject radio frequency (RF) energy into fitting 400, and thus into the feed stack built around fitting 400 (see, e.g., FIG. 10).

A retainer 408 is positioned on second side 405 of base tier 402 to help align and retain a layer of material in electrically conductive contact with second side 405. In the illustrated embodiment, retainer 408 is cylindrical and includes threads 410 on its outside surface to receive a correspondingly threaded nut 414 that then holds the layer of material against second side 405. Other embodiments need not use the illustrated thread-and-nut approach for retention. For instance, in one embodiment retainer 408 could be a slip fit or a radial piece with a flat and a set screw. In another embodiment retainer 408 can be an unthreaded cylinder used for alignment, together with soldering, conductive adhesives, press-fitting, etc. to retain the material layer in contact with second side 405. In still another embodiment, retainer 408 can be an unthreaded cylinder onto which a layer of material is press fit.

Retainer section 408 also includes a hole 412 designed to receive and engage a central alignment pin 416. Central alignment pin 416 is itself adapted to be inserted into central alignment hole 316 on assembly plate 304 (see, e.g., FIG. 3D). Retainer 408 can also include a set screw or some other way to hold central alignment pin 416 in place in retainer 408. In the illustrated embodiment central alignment pin 416 is shown inserted into retainer 408 first, but in other embodiments retainer 408 can be hollow and can mate to a central alignment pin that already extends from the center of the feed assembly plate. In an embodiment with central alignment pin 416 already extends from assembly plate 304, the central alignment pin 416 can be extended or retracted manually, mechanically, hydraulically, electrically, or pneumatically.

In one embodiment, fitting 400 can be formed as a single piece and can be formed from an electrically conductive material, for instance by machining or grinding a metal block. In one embodiment, the electrically conductive material can be a metal such as brass or steel, but in other embodiments fitting 400 can be made of conductive non-metals.

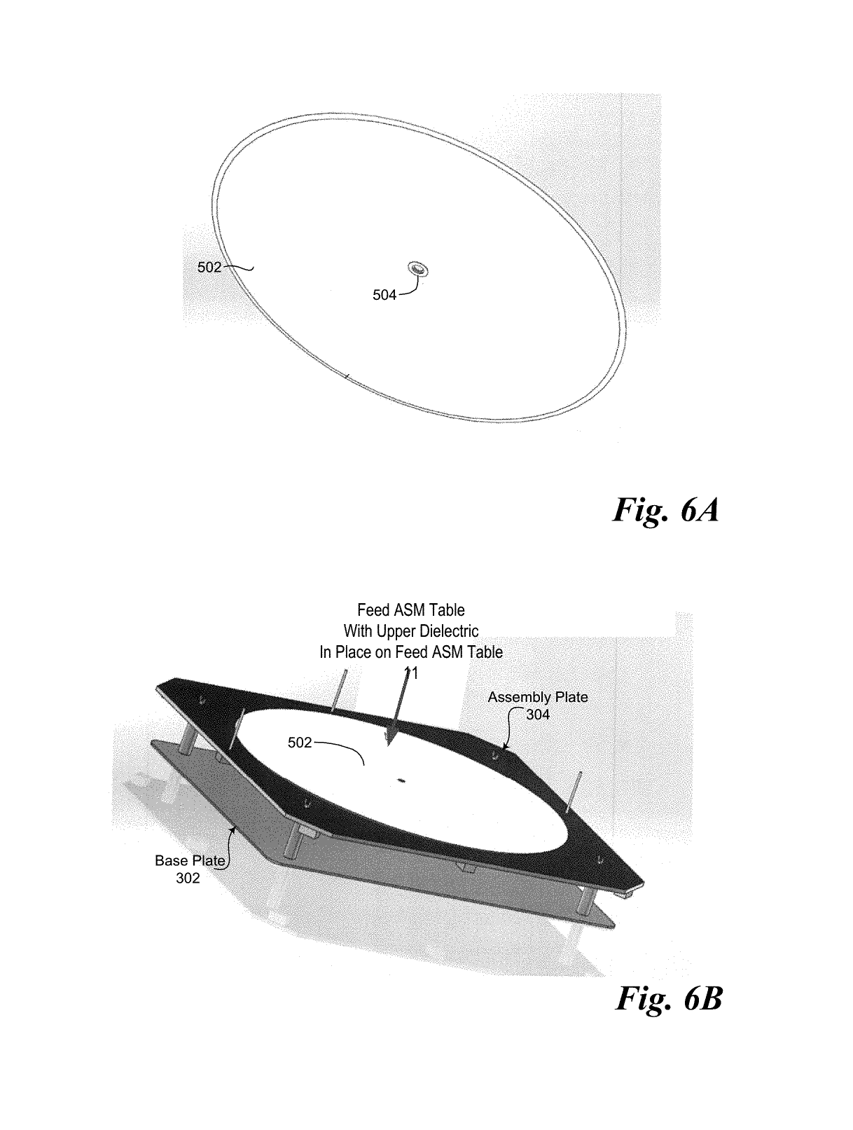

FIGS. 5-10 together illustrate an embodiment of a process for making a feed assembly using tool 300 and fitting 400. FIG. 5 is an exploded cross-sectional drawing illustrating the entire assembly sequence, while FIGS. 6A-9B are perspective drawing illustrating individual steps in the sequence. FIG. 10 is a cross-sectional drawing illustrating the final step in the sequence. In the illustrated process, the components of the multi-layer antenna feed are assembled upside down, with the upper components of the antenna feed going onto the tool first and the lower components going on last—hence why, for example, the first layer put on the tool is referred to is the upper dielectric even though, as shown in the drawing, it appears to be the lower dielectric.

The process starts with tool 300 in the state shown in FIG. 3D, with peripheral alignment pins 314 positioned in assembly plate 304 and a release layer 326 positioned and centered on raised surface 310 with the edge of a release layer 326 aligned with the edge of raised surface. Upper dielectric 502 is first lowered onto release layer 326. In one embodiment upper dielectric 502 is made of a, rigid dielectric and includes one or more locating rings 504 on one of its surfaces. Locating rings 504 are adapted to mate with alignment rings 318 on raised surface 310 of assembly plate 304 (see, e.g., FIGS. 6A-6B).

Once upper dielectric 502 has been lowered onto release layer 326, an adhesive 506 is positioned on the surface of the upper dielectric 502 opposite the surface that rests on release layer 326. In the illustrated embodiment, adhesive 506 is a sheet of pressure-sensitive adhesive (PSA), but in other embodiments other kinds of adhesive can be used. Examples of adhesives that can be used include thermally cured sheet adhesives, dispensed liquid adhesives such as cyanoacrylate, and so on. In the illustrated embodiment PSA layer 506 is illustrated as a sheet of adhesive separate from upper dielectric 502, but in other embodiments PSA layer 506 can be pre-layered or preapplied to the surface of upper dielectric 502, so that it is only necessary to pull back a protective layer. A roller can be used on PSA layer 506 to activate the pressure-sensitive adhesive.

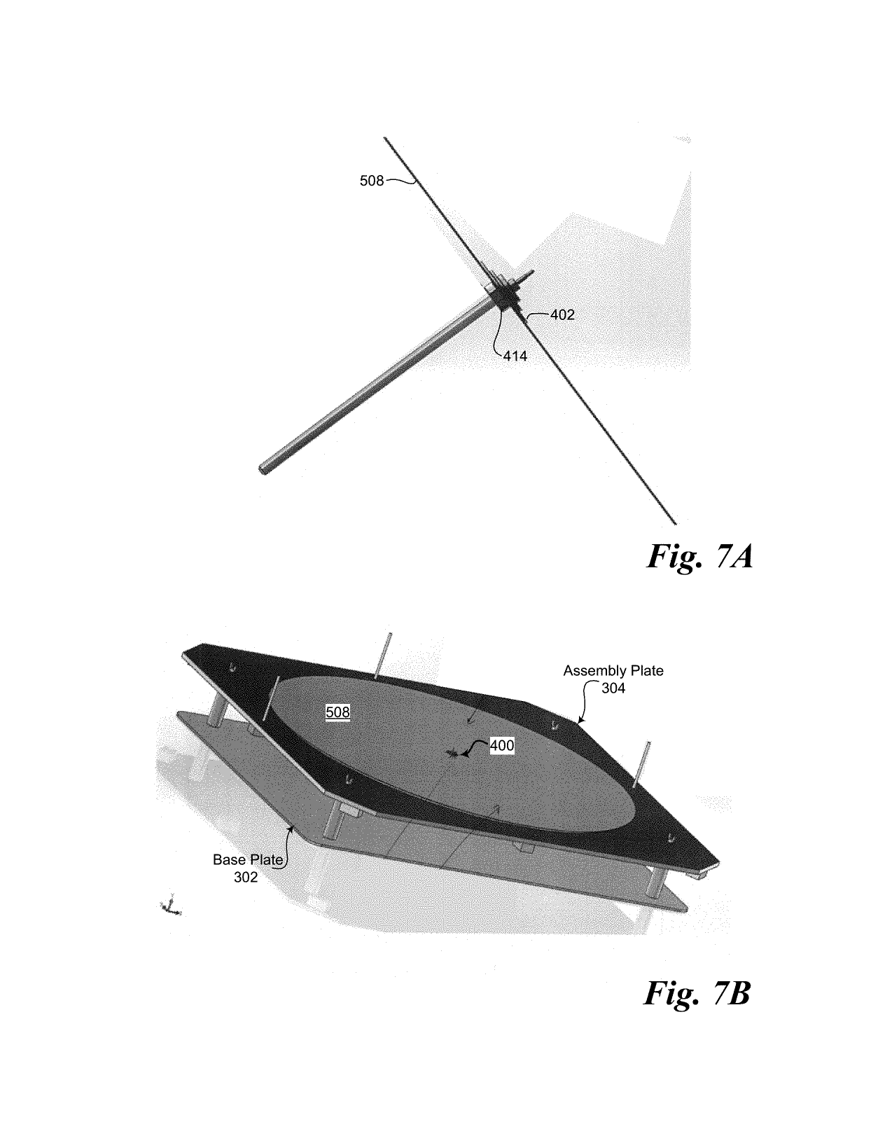

As shown in FIGS. 5 and 7A-7B, before intermediate guide plate (IGP) 508 is lowered onto assembly plate 304 a subassembly is first formed by mounting IGP layer 508 onto fitting 400. IGP 508 forms the conductive layer between the upper dielectric layer and lower dielectric layer. IGP 508 is essentially a layer of an electrically conductive material such as a metal. IGP 508 is placed over retainer 408 (IGP layer 508 has a hole in its designed to receive retainer 408 (see FIG. 4B)). Once IGP layer 508 is positioned on retainer 408, nut 414 is threaded onto threads 410 and tightened until IGP 508 is flush with second side 405 of base tier 402. In one embodiment, nut 414 is torqued down so that the IGP 508 makes substantially 100% physical and electrical contact with the second side 405. In some embodiments this can be critical to performance. In the antenna feed describe above, full and uniform electrical contact between IGP 508 and second side 405 is important to ensure the best impedance match between the coaxial to radial transition. The illustrated embodiment uses a nut, but other embodiments can use other ways of creating full and uniform physical and electrical contact; examples include using electrically conductive adhesives positioned between IGP 508 and second side 405, and soldering IGP 508 to second side 405. Alignment pin 416 is also inserted into retainer 408 to complete the subassembly.

When completed, the whole subassembly (i.e., IGP layer 508, fitting 400, and alignment pin 416) is lowered onto assembly plate 304, with central alignment pin 416 engaging with central alignment hole 316 and pin block 320 to keep the entire subassembly accurately centered. The subassembly is lowered until IGP layer 508 is in contact with PSA layer 506, and another PSA layer 520 is then lowered onto the upper side of IGP 508, with PSA layer 520 surrounding, but not touching, fitting 400. In the illustrated embodiment, PSA layer 520 is a separate sheet, but in other embodiments the PSA can be pre-applied to the upper surface of IGP 508.

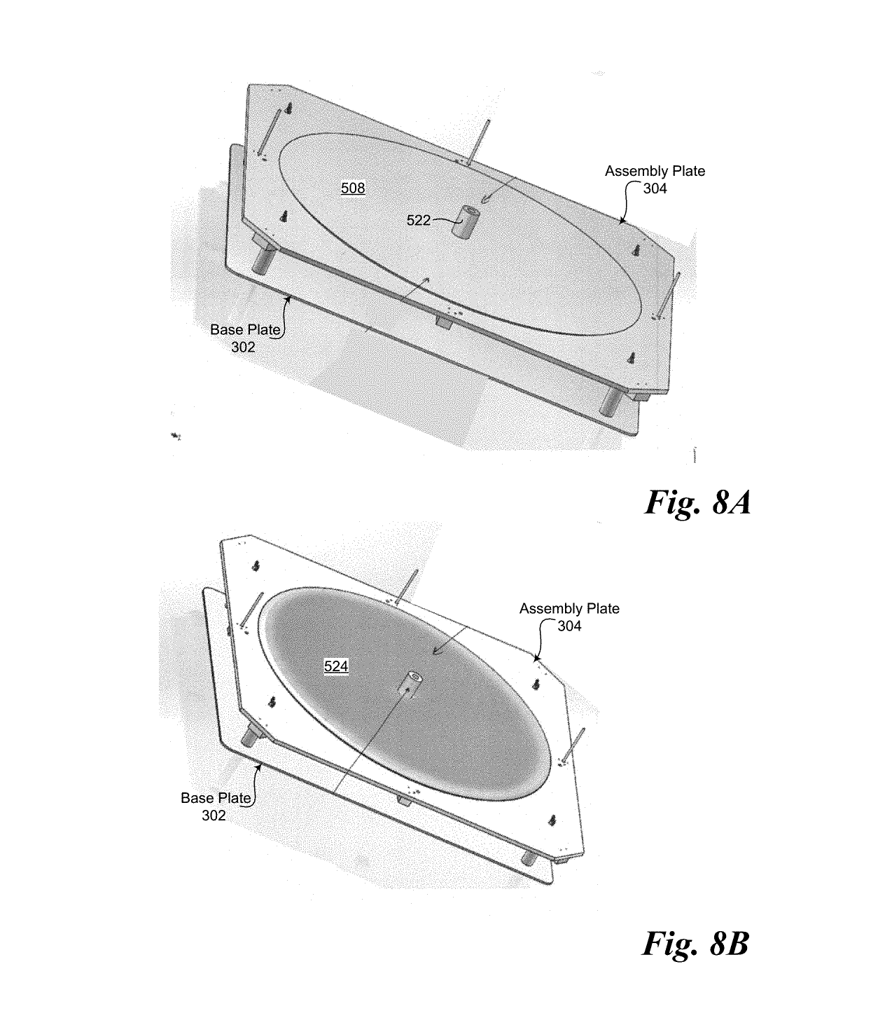

As shown in FIG. 5 and FIGS. 8A-8B, once PSA layer 520 is in place, cannular insert 522 is lowered onto fitting 400. Cannular insert 522 is an annular cylinder with an inside diameter and an outside diameter. The inside diameter of cannular insert 522 is substantially equal to the diameter D of one of the tiers 404a-404c of fitting 400, so that when cannular insert 522 is placed on fitting 400 it fits snugly on one of the tiers and can serve as an accurate centering guide for the material layers that follow. Cannular insert 522 also protects fitting 400, including stem 406, during assembly. Once cannular insert 522 is in place on lower dielectric 524, which has a central hole whose diameter substantially matches the outside diameter of cannular insert 522, it is lowered onto IGP layer 508 and PSA layer 520. In one embodiment, lower dielectric 524 can be a flexible dielectric such as a dielectric foam, but in other embodiments lower dielectric 524 can also be a more rigid dielectric similar to the one used for upper dielectric layer 502.

Once lower dielectric layer 524 is in place on top of PSA layer 520, another PSA layer 525 is placed on top of lower dielectric 524. In one embodiment, PSA layer 525 is an adhesive sheet with a central hole whose diameter is substantially the same as the outer diameter of cannular insert 522, so that cannular insert 522 helps maintain alignment between PSA layer 525 and lower dielectric 524. Once in place on the surface of lower dielectric 524, PSA 520 can be pressed against the surface of lower dielectric layer 524 with a hard roller or similar tool to activate the pressure-sensitive adhesive.

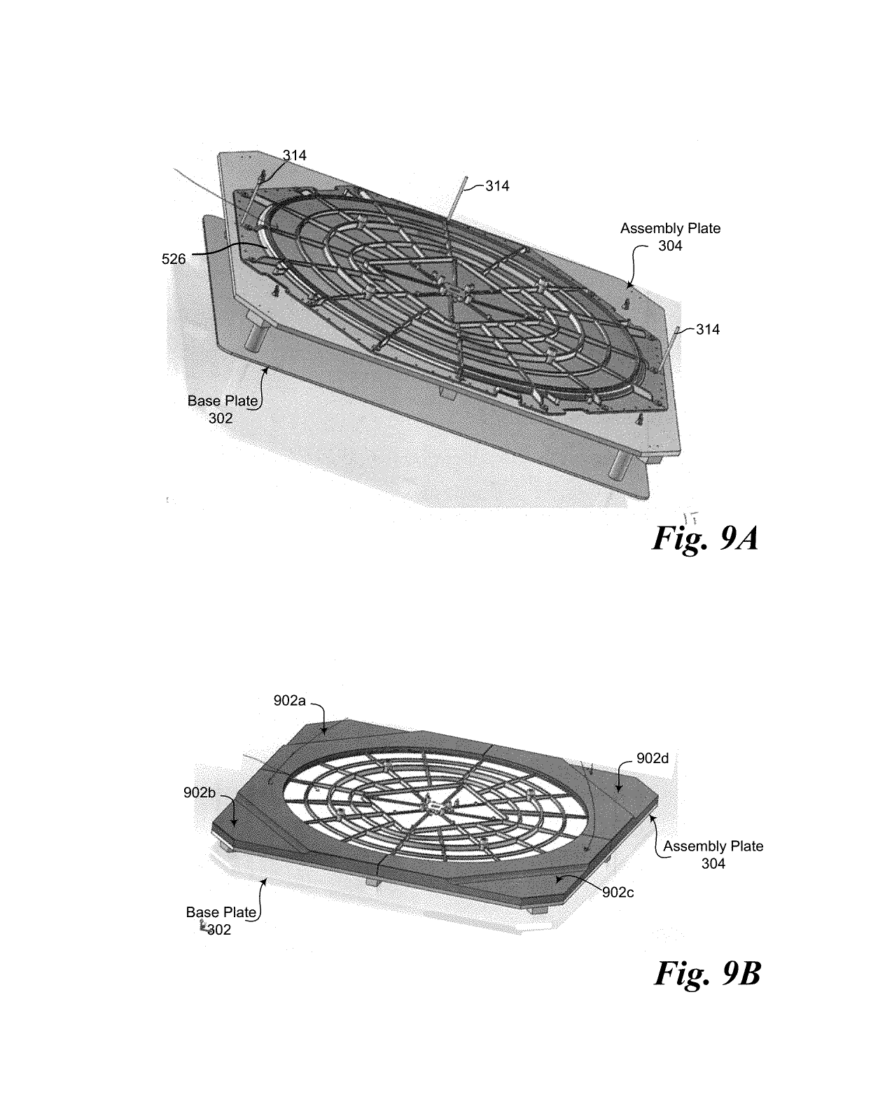

As shown in FIGS. 5 and 9A-9B, once PSA layer 525 is in place, cannular insert 522 is removed and waveguide 526 is lowered onto the rest of the assembly. Holes 528 around the periphery of waveguide 526 are aligned to engage with peripheral alignment pins 314 to keep the waveguide aligned with the other components already on the assembly plate. Waveguide 526 is positioned down all the way, thereby making contact in the middle with the previously assembled components. As shown in FIG. 9B, once waveguide 526 has been positioned on assembly plate 304, a set of covers 902 can optionally be put over the corners of the waveguide. Covers 902A-902D protect the corners of the waveguide and prevent the waveguide from bending while under vacuum as the outside edge are “floating” due to the raised center on the feed assembly plate.

FIG. 10 illustrates the final step in the assembly sequence. The assembly shown in FIG. 10 looks different than the one shown in FIG. 5 because FIG. 5 is a simplified drawing. FIG. 10 illustrates an actual production assembly. After all the components are put onto assembly plate 304, assembly plate 304 is itself detached from uprights 305 that connect it to base plate 302 and the assembly plate, together with the components assembled on it, are inserted into a vacuum chamber 1002. In one embodiment, vacuum chamber 1002 is a vacuum table with a lid that opens and closes.

Once the assembly is inside the vacuum chamber the vacuum is started to ensure the frame seals, thus subjecting the assembly inside to vacuum. Generally, the pressure to which the assembly is subjected and the time to which it is subjected to that pressure will depend on the types of adhesive used. In an embodiment using pressure sensitive adhesives, the assembly is left under vacuum for 10 min at 12 in Hg. The vacuum in the chamber forces the different components together and activates the pressure sensitive adhesive layers, so that the different components in the stack are bonded together. Once bonded, the vacuum is released, and the assembly is removed from the vacuum chamber, and the completed antenna feed is removed from the assembly plate 304.

The use of tool 300 is beneficial in that it provides a surface to align a number of aperture components to a central antenna feed in a manner that allows the antenna assembly to be handled by grabbing the table.

The above description of embodiments is not intended to be exhaustive or to limit the invention to the described forms. Specific embodiments of, and examples for, the invention are described herein for illustrative purposes, but various modifications are possible.

1. A tool comprising:
an assembly plate having a top surface, a bottom surface, and including:
a raised area on the top surface, the raised area centered on a central alignment hole that extends from the top surface to the bottom surface through the entire thickness of the raised area, and
an alignment ring formed in the top surface of the raised area, wherein the alignment ring surrounds the central alignment hole and is concentric with the central alignment hole; and
a fitting shaped into concentric tiers including a base tier, a plurality of stacked concentric tiers of different radii on a first side of the base tier, and a retainer on a second side of the base tier, wherein an axis of the fitting is adapted to be aligned with the center of the central alignment hole.

2. The tool of claim 1 wherein the retainer comprises:
a threaded cylindrical section with a correspondingly threaded nut;
a press-fit cylindrical section; or
a cylindrical section with solder or with an electrically conductive adhesive.

3. The tool of claim 1, further comprising a central alignment pin inserted into a hole in the retainer of the fitting, wherein the central alignment pin is adapted to be inserted into the central alignment hole so that a center of the fitting is aligned with the center of the central alignment hole.

4. The tool of claim 3, further comprising a pin block attached to the lower surface of the assembly plate and surrounding the central alignment hole, the pin block including a set screw to engage the central alignment pin.

5. The tool of claim 1, further comprising a release layer positioned on the raised area, the release layer having a size and shape that substantially correspond to the size and shape of the raised area.

6. The tool of claim 5 wherein the release layer is a layer of mesh.

7. The tool of claim 1, further comprising one or more peripheral alignment pins extending upward from the top surface of the assembly plate off the raised area.

8. The tool of claim 1, further comprising a cannular insert adapted to mate with the fitting, the cannular insert having an inner diameter and an outer diameter, the inner diameter substantially matching the outer diameter of one of the stacked concentric tiers of the fitting.

9. The tool of claim 1, further comprising a vacuum chamber within which the assembly plate and any layers of material positioned on the assembly plate can be subjected to a vacuum.

10. The tool of claim 9, further comprising a set of covers positioned at each corner of the assembly plate to cover the corners of a waveguide positioned on the assembly plate and protect them from being bent by the forces caused by the vacuum.

11. The tool of claim 1, further comprising:
a base plate; and
a plurality of uprights extending between the base plate and the assembly plate so that the assembly plate is spaced apart from, and removably attached to, the base plate by the plurality of uprights.

12. A process comprising:
aligning an upper dielectric on an assembly plate, the assembly plate having a top surface, a bottom surface, and including:
a raised area on the top surface, the raised area centered on a central alignment hole that extends from the top surface to the bottom surface through the entire thickness of the raised area, and
an alignment ring formed in the top surface of raised area, wherein the alignment ring surrounds the central alignment hole and is concentric with the central alignment hole, wherein the upper dielectric is aligned so that its center coincides with the center of the alignment hole;
on a fitting including a base tier, a plurality of stacked concentric tiers of different radii on a first side of the base tier, and a retainer on a second side of the base tier, placing an electrically conductive intermediate guide plate against the second side of the base tier and retaining the intermediate guide plate in place;
positioning the fitting and the intermediate guide plate on the upper dielectric with an axis of the fitting aligned with the center of the alignment hole;
positioning a lower dielectric on the intermediate guide plate; and
positioning a waveguide on the lower dielectric layer.

13. The process of claim 12 wherein retaining the intermediate guide plate in place comprises:
positioning the intermediate guide plate on a threaded cylindrical section and keeping it in electrical contact with the base tier with a correspondingly threaded nut;
press-fitting the intermediate guide plate onto a cylindrical section such that it is in electrical contact with the base tier; or
positioning the intermediate guide plate on a cylindrical section and keeping it in electrical contact with the base tier with solder or with an electrically conductive adhesive.

14. The process of claim 12, further comprising placing a release layer between the top surface of raised area and the upper dielectric, the release layer having a size and shape that substantially correspond to the size and shape of the raised area.

15. The process of claim 14 wherein the release layer is a layer of mesh.

16. The process of claim 12 wherein positioning the lower dielectric on the intermediate guide plate comprises:
placing a cannular insert on the fitting, the cannular insert having an inner diameter and an outer diameter, the inner diameter substantially matching the outer diameter of one of the stacked concentric tiers of the fitting; and
lowering the lower dielectric onto the intermediate guide plate so that the cannular insert fits into a hole at the center of the lower dielectric, the hole having a diameter substantially equal to the outer diameter of the cannular insert.

17. The process of claim 12, further comprising:
inserting a central alignment pin into a hole in the retainer of the fitting; and
inserting the central alignment pin into the central alignment hole to align a center of the fitting with the center of the central alignment hole.

18. The process of claim 17, further comprising:
attaching a pin block on the lower side of the assembly plate; and
fixing the central alignment pin in the pin block using a set screw positioned in the pin block.

19. The process of claim 12, wherein positioning the waveguide on the lower dielectric layer comprises:
aligning holes on the periphery of the waveguide with one or more peripheral alignment pins positioned around the periphery of the assembly plate off the raised area; and
lowering the waveguide onto the lower dielectric layer.

20. The process of claim 12, further comprising inserting the assembly plate, the upper dielectric, the fitting, the intermediate guide plate, the lower dielectric, and the waveguide into a vacuum chamber and applying a vacuum to the vacuum chamber.

21. The process of claim 12, further comprising positioning a set of covers at each corner of the assembly plate to cover the corners of a waveguide positioned on the assembly plate and protect them from being bent by the forces caused by the vacuum.

22. The process of claim 12, further comprising:
positioning an adhesive between the upper dielectric and the intermediate guide plate;
positioning an adhesive between the intermediate guide plate and the lower dielectric; and
positioning an adhesive between the lower dielectric and the waveguide.

23. The process of claim 12, wherein the upper dielectric layer includes a locating ring, and wherein positioning the upper dielectric layer on the assembly plate comprises inserting the alignment ring of the assembly plate into the locating ring of the upper dielectric layer.
